(19) United States
(12) Patent Application Publication
(10) Pub. No.: US 2025/0202877 A1
(43) Pub. Date: Jun. 19, 2025

(54) AUTHENTICATION DEVICE, AUTHENTICATION METHOD, AND AUTHENTICATION SYSTEM

(71) Applicant: PANASONIC INTELLECTUAL PROPERTY MANAGEMENT CO., LTD., Osaka (JP)

(72) Inventors: Shigeo KASAHARA, Hyogo (JP); Satoru TANAHASHI, Osaka (JP)

(73) Assignee: PANASONIC INTELLECTUAL PROPERTY MANAGEMENT CO., LTD., Osaka (JP)

(21) Appl. No.: 18/849,206

(22) PCT Filed: Mar. 22, 2023
(86) PCT No.: PCT/JP2023/011328

§ 371 Date: Nov. 20, 2024

(30) Foreign Application Priority Data
Mar. 23, 2022 (JP) 2022-047176

(51) Int. Cl. H04L 9/40

(52) U.S. Cl. CPC H04L 63/08

(57) ABSTRACT

An authentication device belonging to an authentication system including N authentication devices (N is an integer constant equal to or greater than 2), the authentication device including: an authentication unit configured to execute authentication processing of an authentication object based on authentication information of the authentication object; and a communication unit configured to transmit the authentication information via a network to at least one of (N−1) other authentication devices which are of the N authentication devices and are other than the own authentication device.

### TECHNICAL FIELD

The present disclosure relates to an authentication device, an authentication method, and an authentication system.

### BACKGROUND ART

Patent Literature 1 discloses a face authentication system including a terminal device and a server device for face authentication. The terminal device includes an image acquisition unit that acquires an image of a person to be authenticated, an image processing unit that specifies a region of a face of the person to be authenticated from the acquired image, and cuts out an image of a central portion of the face in a range narrower than a contour of the face from the specified region of the face, and a transmission unit that transmits the image of the central portion of the face to the server device. The server device includes a receiving unit that receives the transmitted image of the central portion of the face, and an authentication processing unit that executes face authentication processing based on the received image of the central portion of the face.

### CITATION LIST

### Patent Literature

Patent Literature 1: WO2019/244663

### SUMMARY OF INVENTION

### Technical Problem

In Patent Literature 1, authentication processing related to identity verification of a person is executed not by the terminal device but by the server device. In view of the possibility that an authentication object (for example, a person) may increase, the number of terminal devices is increased, and an authentication system using a plurality of terminal devices and one server device is defined. In this case, the server device may receive and acquire authentication information transmitted from each of the plurality of terminal devices and perform authentication processing using each piece of the authentication information in parallel. As a result, as a load on the server device increases, a lot of time is required to perform authentication processing in the server device, and it is difficult to quickly perform authentication processing. Therefore, improvement in efficiency of authentication processing is required.

The present disclosure has been made in view of the above related situation, and an object of the present disclosure is to avoid overconcentration of processing execution on a specific device and to improve efficiency of authentication processing of an authentication object.

### Solution to Problem

The present disclosure provides an authentication device belonging to an authentication system including N authentication devices (N is an integer constant equal to or greater than 2), the authentication device including: an authentication unit configured to execute authentication processing of an authentication object based on authentication information of the authentication object; and a communication unit configured to transmit the authentication information via a network to at least one of (N−1) other authentication devices which are of the N authentication devices and are other than the own authentication device.

The present disclosure provides an authentication method performed by an authentication device belonging to an authentication system including N authentication devices (N is an integer constant equal to or greater than 2), the authentication method including: executing authentication processing of an authentication object based on authentication information of the authentication object; and transmitting the authentication information via a network to at least one of (N−1) other authentication devices which are of the N authentication devices and are other than the own authentication device.

The present disclosure provides an authentication system including: a server device; and N authentication devices (N is an integer constant equal to or greater than 2), in which the authentication device is configured to execute authentication processing of an authentication object based on authentication information of the authentication object, and transmit and receive the authentication information to and from the server device, or to and from at least one of (N−1) other authentication devices which are of the N authentication devices and are other than the own authentication device.

These comprehensive or specific aspects may be implemented by a system, a device, a method, an integrated circuit, a computer program, or a recording medium, and may be implemented by any combination of the system, the device, the method, the integrated circuit, the computer program, and the recording medium.

### Advantageous Effects of Invention

According to the present disclosure, overconcentration of processing execution on a specific device can be avoided, and efficiency of authentication processing of an authentication object can be improved.

### BRIEF DESCRIPTION OF DRAWINGS

FIG. 1 is a diagram illustrating an authentication system according to the present embodiment.

FIG. 2 is a block diagram of a client authentication terminal according to the present embodiment.

FIG. 3 is a block diagram of a server authentication device according to the present embodiment.

FIG. 4 is a block diagram of a server authentication device having an authentication information input function.

FIG. 5 is a flowchart of authentication processing of a person in the client authentication terminal.

FIG. 6 is a flowchart of cooperation processing of inter-client cooperation information executed by the client authentication terminal.

FIG. 7 is a diagram illustrating an example of the inter-client cooperation information.

FIG. 8 is a diagram illustrating an example of a transmission destination of the inter-client cooperation information based on conditions.

FIG. 9 is a sequence diagram illustrating a case in which a person moves among a plurality of client authentication terminals and performs authentication.

FIG. 10 is a sequence diagram illustrating a case in which the person performs authentication in an authentication system including a server authentication device having an authentication information input function.

FIG. 11 is a flowchart of authentication of a person in the server authentication device.

### DESCRIPTION OF EMBODIMENTS

Hereinafter, embodiments that specifically disclose an authentication device, an authentication method, and an authentication system according to the present disclosure will be described in detail with reference to the drawings as appropriate. However, unnecessarily detailed description may be omitted. For example, detailed description of already well-known matters and redundant description of substantially the same configuration may be omitted. This is to avoid unnecessary redundancy of the following description and to facilitate understanding of those skilled in the art. The accompanying drawings and the following description are provided for those skilled in the art to fully understand the present disclosure, and are not intended to limit the subject matter described in the claims.

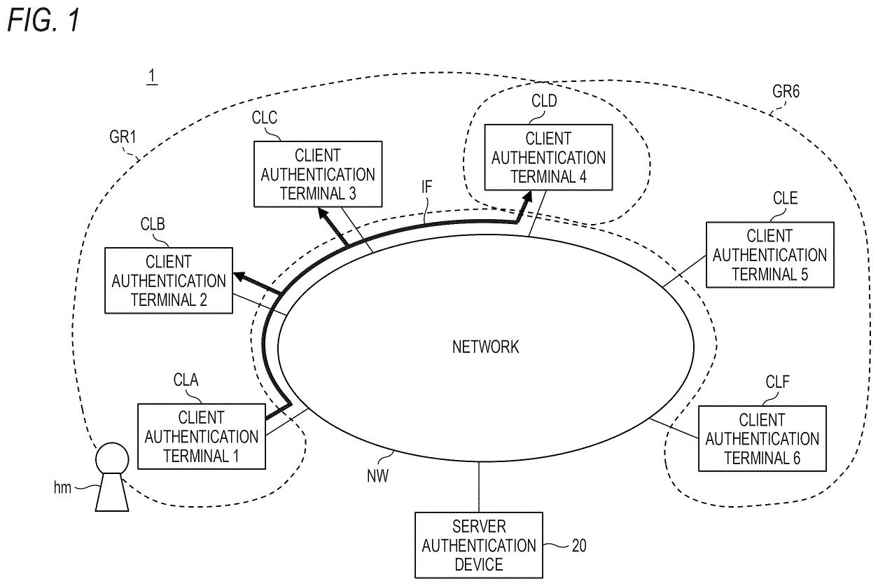

A concept of the authentication system according to the present embodiment will be described with reference to FIG. 1. FIG. 1 is a diagram illustrating the authentication system according to the present embodiment.

An authentication system 1 includes a client authentication terminal CLA, a client authentication terminal CLB, a client authentication terminal CLC, a client authentication terminal CLD, a client authentication terminal CLE, a client authentication terminal CLF, and a server authentication device 20. In the following description, for convenience of description, each client authentication terminal is assigned a serial number (specifically, 1, 2, 3, 4, 5, 6), and the client authentication terminals CLA, CLB, CLC, CLD, CLE, and CLF may be referred to as client authentication terminals 1, 2, 3, 4, 5, and 6, respectively. The client authentication terminal CLA, the client authentication terminal CLB, the client authentication terminal CLC, the client authentication terminal CLD, the client authentication terminal CLE, the client authentication terminal CLF, and the server authentication device 20 are communicably connected via a network NW. The number of client authentication terminals constituting the authentication system 1 is six in FIG. 1, but is not limited to this number.

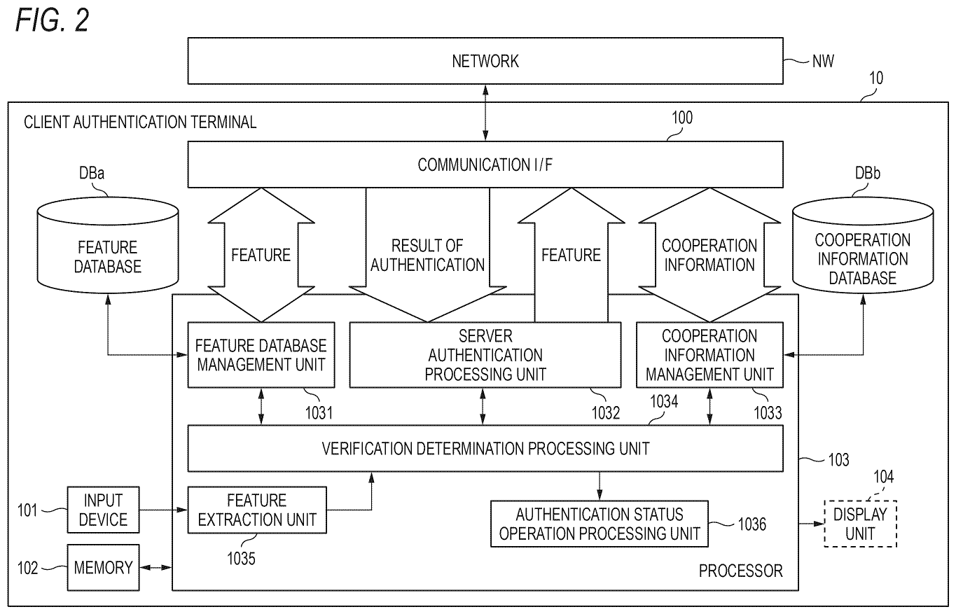

The authentication system 1 is installed so as to be available in an area such as a tourist destination. Each of the plurality of client authentication terminals is installed in a tourist facility or a tourist spot or the like in the tourist destination. A person (for example, a tourist) performs authentication of identity verification by the client authentication terminal installed in each tourist facility or the like. The person may visit a plurality of tourist facilities existing in the tourist destination and may receive services available at those tourist facilities. Therefore, the authentication system 1 cooperates information related to authentication of the person (hereinafter, referred to as authentication information) among the plurality of client authentication terminals. The information related to authentication is, for example, information to be used for authentication processing. The authentication information will be described in detail with reference to FIG. 2. Accordingly, even when the person visits other tourist facilities and performs authentication by the client authentication terminals installed in the tourist facilities, the authentication of identity verification can be performed smoothly. The authentication system 1 is not limited to being used in a tourist destination, but may also be used in an amusement park, a theme park, a stadium, or the like. Further, the authentication system 1 may be installed across a plurality of tourist destinations.

In the authentication system 1 according to the present embodiment, when the plurality of client authentication terminals cooperate with each other, at least one group of the client authentication terminals is defined. For example, in FIG. 1, two groups (for example, groups GR1 and GR6) are defined.

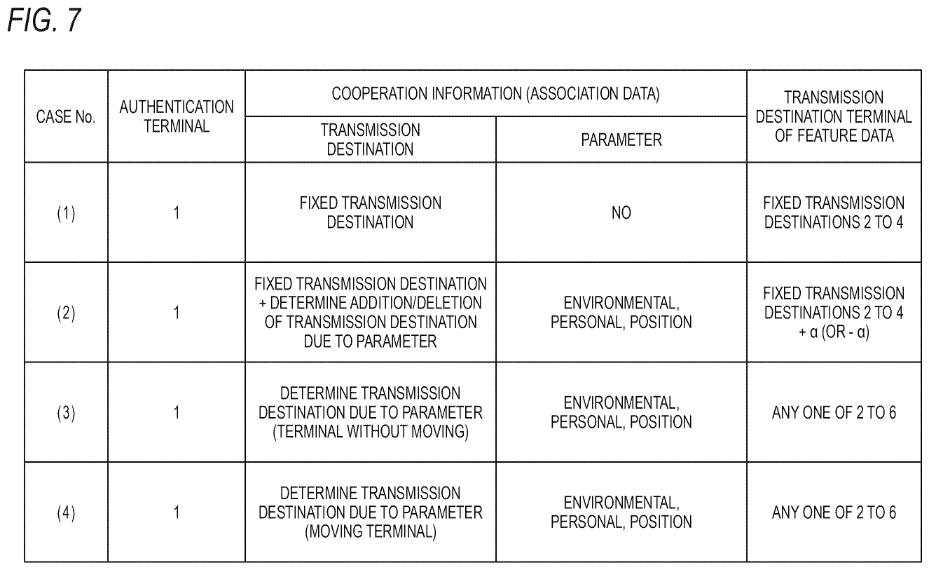

The group GR1 is a group of client authentication terminals set in advance when the client authentication terminal CLA cooperates the authentication information. The client authentication terminal CLA cooperates (in other words, shares) the authentication information with the client authentication terminal CLB, the client authentication terminal CLC, and the client authentication terminal CLD. The client authentication terminal CLB, the client authentication terminal CLC, and the client authentication terminal CLD are referred to as fixed transmission destinations for the client authentication terminal CLA. That is, according to the group GR1, the authentication information from the client authentication terminal CLA is transmitted to the client authentication terminals CLB, CLC, and CLD. The client authentication terminal CLA may transmit the cooperation of the authentication information not only to the fixed transmission destinations but also to other client authentication terminals (see FIG. 7). In addition, the client authentication terminal CLA may not necessarily cooperate the authentication information to all of the fixed transmission destinations (see FIG. 7).

The group GR6 is a group of client authentication terminals set in advance when the client authentication terminal CLF cooperates the authentication information. The client authentication terminal CLF cooperates (in other words, shares) the authentication information with the client authentication terminal CLD and the client authentication terminal CLE, which serve as fixed transmission destinations. The client authentication terminal CLF may transmit the cooperation of the authentication information not only to the fixed transmission destinations but also to other client authentication terminals (see FIG. 7). In addition, the client authentication terminal CLF may not necessarily cooperate the authentication information to all of the fixed transmission destinations (see FIG. 7).

The client authentication terminals will be described using the client authentication terminal CLA as a representative example. For example, when a person hm who is an authentication object approaches the client authentication terminal CLA, the client authentication terminal CLA authenticates identity verification of the person hm. A timing for the authentication of the identity verification of the person hm is not limited to the timing when the person hm approaches the client authentication terminal CLA. A method for authenticating identity verification of a person will be described in detail with reference to FIG. 2. When being successful in the authentication of the person hm, the client authentication terminal CLA transmits the authentication information (information IF) to the fixed transmission destinations (for example, the client authentication terminal CLB, the client authentication terminal CLC, and the client authentication terminal CLD). The client authentication terminal CLA may transmit the information IF to the server authentication device 20. The other client authentication terminals also operate similarly with regard to the authentication operation of the identity verification of the person and the cooperation of the authentication information.

Next, a hardware configuration of the client authentication terminal according to the present embodiment will be described with reference to FIG. 2. FIG. 2 is a block diagram of the client authentication terminal according to the present embodiment.

A client authentication terminal 10 includes at least a communication I/F 100, a feature database DBa, a cooperation information database DBb, a processor 103, an input device 101, and a memory 102. The client authentication terminal 10 may further include a display unit 104. The client authentication terminal 10 may be a tablet, a personal computer (PC), a mobile terminal, or a housing equipped with a device for biometric authentication. The client authentication terminal 10 is one of N (N is an integer constant equal to or greater than 2) client authentication terminals belonging to the authentication system 1.

The communication I/F 100 is a network interface circuit that performs wireless or wired communication with the network NW. Here, I/F represents an interface. The client authentication terminal 10 is communicably connected to the server authentication device (see FIG. 1) and other client authentication terminals via the communication I/F 100 and the network NW. The client authentication terminal 10 may directly communicate with the server authentication device or other client authentication terminals without using the network NW. The communication I/F 100 transmits the authentication information via the network NW to at least one of (N−1) other client authentication terminals which are of the N client authentication terminals and are other than the own client authentication terminal. The communication I/F 100 may transmit and receive a plurality of types of authentication information. Examples of a communication method used for communication of the communication I/F 100 include mobile communication such as a wide area network (WAN), a local area network (LAN), a long term evolution (LTE), and 5G, power line communication, near field communication (for example, Bluetooth (registered trademark) communication), or communication for mobile phones.

The feature database DBa is implemented by a storage medium (for example, a flash memory, a hard disk drive (HDD), and a solid state drive (SSD)). The feature database DBa stores data (hereinafter, referred to as a registered feature) indicating characteristic data of a person to be used in the authentication processing and data (hereinafter, referred to as an extracted feature) input to the input device 101 and extracted by a feature extraction unit 1035. The registered feature and the extracted feature are collectively referred to as feature data. The feature data is an example of the authentication information. The registered feature is data used to perform identity verification in the authentication processing of a person, and for example, may be information such as a name, an ID, or a face photo of the person, or biometric information such as a fingerprint previously extracted from the person. The registered feature is not limited thereto. The extracted feature is data used to perform identity verification in the authentication processing of the person, and may be a fingerprint, face data, or voice data. The extracted feature is not limited thereto. That is, the feature database DBa stores the authentication information of the authentication object. The feature database DBa transmits the feature data to a feature database management unit 1031. The feature database DBa stores the feature data acquired from the feature database management unit 1031 as needed.

The cooperation information database DBb is implemented by a storage medium (for example, a flash memory, a HDD, and an SSD). The cooperation information database DBb stores information related to cooperation (more specifically, sharing or transmission) of authentication information of a person between the client authentication terminal 10 and other client authentication terminals (hereinafter, referred to as inter-client cooperation information). The inter-client cooperation information includes, for example, information of the fixed transmission destination, information of an installation position of each client authentication terminal, information of a condition for determining a transmission destination of various types of information, information for determining data used for verification determination of a person, cooperation information associated with each person, and information related to an expiration date of various types of information. The information for determining data used for verification determination of a person is information regarding whether to use either or both of the registered feature and the extracted feature for the verification determination. The cooperation information associated with each person is, for example, cooperation information determined based on the sex, nationality, and preference of a person. The inter-client cooperation information includes the authentication information and the expiration date information of the inter-client cooperation information. Examples of the inter-client cooperation information are merely examples, and the inter-client cooperation information is not limited thereto. That is, the cooperation information database DBb stores the inter-client cooperation information between N authentication devices. The cooperation information database DBb transmits the inter-client cooperation information to a cooperation information management unit 1033. The cooperation information database DBb stores the inter-client cooperation information acquired from the cooperation information management unit 1033 as needed.

The input device 101 inputs information of a person who visits an installation position of the client authentication terminal 10. For example, the input device 101 is a camera, a fingerprint authentication device, a microphone, a scanner, or a touch panel display. Examples of the input device 101 are merely examples, and the input device 101 is not limited thereto. The client authentication terminal 10 may include a plurality of devices, not just one, as the input device 101. When being a camera, the input device 101 images a face of the person to acquire data of the face. When being a camera, the input device 101 may acquire vital information (for example, body temperature or pulse rate). When being a microphone, the input device 101 acquires voice of the person. When being a touch panel display, the input device 101 receives input of information of the person (for example, a name, an ID, or a password). When being a scanner, the input device 101 reads a bar code or a QR code (registered trademark) of the person. The input device 101 transmits the acquired data to the feature extraction unit 1035.

The memory 102 includes, for example, a random access memory (RAM) as a work memory used when each processing of the processor 103 is executed, and a read only memory (ROM) storing a program and data defining an operation of the processor 103. The RAM temporarily stores data or information generated or acquired by the processor 103. The program that defines the operation of the processor 103 is written into the ROM.

The processor 103 is implemented by, for example, a central processing unit (CPU), a digital signal processor (DSP), a graphical processing unit (GPU), or a field programmable gate array (FPGA), and performs various types of processing and control in cooperation with the memory 102. Specifically, the processor 103 executes various types of operations to be performed by the processor 103 by referring to the program and data retained in the memory 102 and executing the program.

The processor 103 integrally controls the client authentication terminal 10. The processor 103 implements functions of the feature database management unit 1031, a server authentication processing unit 1032, the cooperation information management unit 1033, a verification determination processing unit 1034, the feature extraction unit 1035, and an authentication status operation processing unit 1036. During operation, the processor 103 uses the RAM of the memory 102 to temporarily store data generated or acquired by each unit of the processor 103.

The feature database management unit 1031 manages the feature data. The feature database management unit 1031 transmits the feature data acquired from the feature database DBa to the verification determination processing unit 1034. The feature database management unit 1031 manages transmission and reception of the feature data to and from the communication I/F 100. The feature database management unit 1031 acquires, from the verification determination processing unit 1034, the extracted feature extracted by the feature extraction unit 1035, and transmits the extracted feature to the feature database DBa. The feature database management unit 1031 may directly acquire the extracted feature from the feature extraction unit 1035.

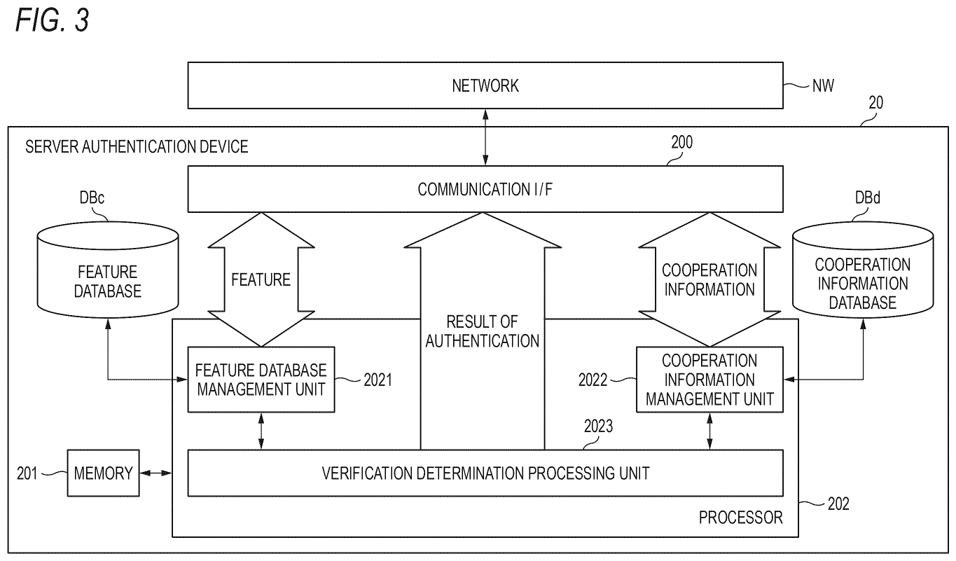

The server authentication processing unit 1032 manages an instruction to the server authentication device 20 (see FIG. 3). When the verification determination processing unit 1034 fails in verification determination, the server authentication processing unit 1032 generates an instruction to cause the server authentication device 20 to perform verification determination. The server authentication processing unit 1032 transmits the generated instruction and the feature data to the server authentication processing unit 1032 via the communication I/F 100. The server authentication processing unit 1032 acquires a result of the authentication processing executed by the server authentication device 20 from the communication I/F 100. The server authentication processing unit 1032 outputs the result of the authentication processing executed by the server authentication device 20 to the verification determination processing unit 1034. The server authentication processing unit 1032 may output the result of the authentication processing executed by the server authentication device 20 to the authentication status operation processing unit 1036.

The cooperation information management unit 1033 manages the inter-client cooperation information. The cooperation information management unit 1033 manages the inter-client cooperation information including the expiration date information and the authentication information of the authentication object. The cooperation information management unit 1033 transmits the cooperation information acquired from the cooperation information database DBb to the verification determination processing unit 1034. The cooperation information management unit 1033 transmits the inter-client cooperation information to the communication I/F 100 in order to transmit the inter-client cooperation information to other client authentication terminals and the server authentication device 20. The cooperation information management unit 1033 acquires the inter-client cooperation information transmitted from the other client authentication terminals. The cooperation information management unit 1033 deletes the authentication information of the authentication object and the inter-client cooperation information having a passed expiration date.

The verification determination processing unit 1034 performs verification determination of a person based on the registered feature acquired from the feature database management unit 1031 and/or the extracted feature extracted by the feature extraction unit 1035. That is, the verification determination processing unit 1034 executes the authentication processing of the authentication object based on the authentication information of the authentication object. The verification determination processing unit 1034 may perform multi-factor authentication. Here, the multi-factor authentication means that the verification is executed based on a plurality of pieces of feature data, for example, the verification determination is executed based on face data and fingerprint data. The verification determination processing unit 1034 transmits a result of the verification determination to the authentication status operation processing unit 1036. In addition, in response to acquiring the result of the verification determination executed by the server from the server authentication processing unit 1032, the verification determination processing unit may transmit the result to the authentication status operation processing unit 1036.

The feature extraction unit 1035 extracts a feature from data acquired from the input device 101. The feature extraction unit 1035 transmits the extracted feature to the verification determination processing unit 1034.

The authentication status operation processing unit 1036 performs an operation according to the result of the verification determination acquired from the verification determination processing unit 1034. When the result of the verification determination is successful, the operation may be, for example, an operation of opening a gate installed in the vicinity of the client authentication terminal 10, and displaying “authentication successful” on the display unit 104. When the result of the verification determination is failed, the operation may be, for example, an operation of sounding a buzzer sound from a speaker mounted on the client authentication terminal 10, closing the gate, and displaying “authentication failed” on the display unit 104.

The display unit 104 is, for example, a display. The display unit 104 displays the result of the verification determination or the situation of the verification determination processing. The client authentication terminal 10 may not include the display unit 104.

Next, a hardware configuration of the server authentication device according to the present embodiment will be described with reference to FIG. 3. FIG. 3 is a block diagram of the server authentication device according to the present embodiment.

The server authentication device 20 includes a communication I/F 200, a feature database DBc, a cooperation information database DBd, a memory 201, and a processor 202.

The communication I/F 200 is a network interface circuit that performs wireless or wired communication with the network NW. The server authentication device 20 is communicably connected to the client authentication terminal 10 (see FIG. 2) via the communication I/F 200 and the network NW. The server authentication device 20 may be communicably connected to a plurality of client authentication terminals as in the example illustrated in FIG. 1, or may be communicably connected to other server authentication devices. The server authentication device 20 may directly communicate with the client authentication terminal 10 without using the network NW. Examples of a communication method used for communication in the communication I/F 200 include mobile communication such as WAN, LAN, LTE, and 5G, power line communication, near field communication (for example, Bluetooth (registered trademark) communication), or communication for mobile phones. The communication I/F 200 acquires the feature data transmitted from the client authentication terminal 10 via the network NW. The communication I/F 200 transmits the acquired feature data to a feature database management unit 2021.

The feature database DBc is implemented by a storage medium (for example, a flash memory, a HDD, and an SSD). The feature database DBc stores the feature data. The feature database DBc retains all registered features, and may retain all or a part of extracted features obtained by a client authentication terminal or a server having an authentication information input function connected via the network NW. For example, in the example illustrated in FIG. 1, the feature database DBc retains all the features. The feature database DBc may retain all extracted features retained by the client authentication terminal CLA, the client authentication terminal CLB, the client authentication terminal CLC, the client authentication terminal CLD, the client authentication terminal CLE, and the client authentication terminal CLF, respectively. Alternatively, the feature database DBc may retain only the extracted feature obtained by the server authentication device having the authentication information input function or the client authentication terminal visited first. Alternatively, the feature database DBc may retain only the latest extracted feature or may not retain the extracted feature. The feature database DBc transmits the feature data to the feature database management unit 2021. The feature database DBc stores the feature data acquired from the feature database management unit 2021 as needed.

The cooperation information database DBd is implemented by a storage medium (for example, a flash memory, a HDD, and an SSD). The cooperation information database DBd retains the inter-client cooperation information for all or a part of the plurality of client authentication terminals to which the server authentication device 20 is communicably connected. For example, in the example illustrated in FIG. 1, the cooperation information database DBd retains the inter-client cooperation information retained by the client authentication terminal CLA, the client authentication terminal CLB, the client authentication terminal CLC, the client authentication terminal CLD, the client authentication terminal CLE, and the client authentication terminal CLF, respectively. The cooperation information database DBd transmits the inter-client cooperation information to a cooperation information management unit 2022. The cooperation information database DBd stores the inter-client cooperation information acquired from the cooperation information management unit 2022 as needed.

The memory 201 includes, for example, a RAM as a work memory used when each processing of the processor 202 is executed, and a ROM that stores a program and data that define an operation of the processor 103. The RAM temporarily stores data or information generated or acquired by the processor 202. The program that defines the operation of the processor 202 is written into the ROM.

The processor 202 is implemented by, for example, a CPU, a DSP, a GPU, or a FPGA, and performs various types of processing and control in cooperation with the memory 201. Specifically, the processor 202 executes various types of operations to be performed by the processor 202 by referring to the program and data retained in the memory 201 and executing the program. The processor 202 integrally controls the server authentication device 20. The processor 202 implements functions of the feature database management unit 2021, the cooperation information management unit 2022, and a verification determination processing unit 2023. During operation, the processor 202 uses the RAM of the memory 201 to temporarily store data generated or acquired by each unit of the processor 202.

The feature database management unit 2021 manages the feature data. The feature database management unit 2021 transmits the feature data acquired from the feature database DBc to the verification determination processing unit 2023. The feature database management unit 2021 manages transmission and reception of the feature data to and from the communication I/F 200. The feature database management unit 2021 transmits the feature data acquired from the communication I/F 200 to the verification determination processing unit 2023 and the feature database DBc.

The cooperation information management unit 2022 manages the cooperation information. The cooperation information management unit 2022 transmits the cooperation information acquired from the cooperation information database DBd to the verification determination processing unit 2023. The cooperation information management unit 2022 transmits the inter-client cooperation information to the communication I/F 200 in order to transmit the inter-client cooperation information to the client authentication terminal 10. The cooperation information management unit 1033 acquires the inter-client cooperation information transmitted from the client authentication terminal 10. The cooperation information management unit 2022 deletes the inter-client cooperation information having a passed expiration date.

The verification determination processing unit 2023 performs verification determination of a person based on the feature data acquired from the feature database management unit 2021. The verification determination processing unit 2023 may perform multi-factor authentication in which authentication processing is performed by using a plurality of types of authentication information (for example, face image data for face authentication and fingerprint data for fingerprint authentication). The verification determination processing unit 2023 transmits a result of the verification determination to the communication I/F 200.

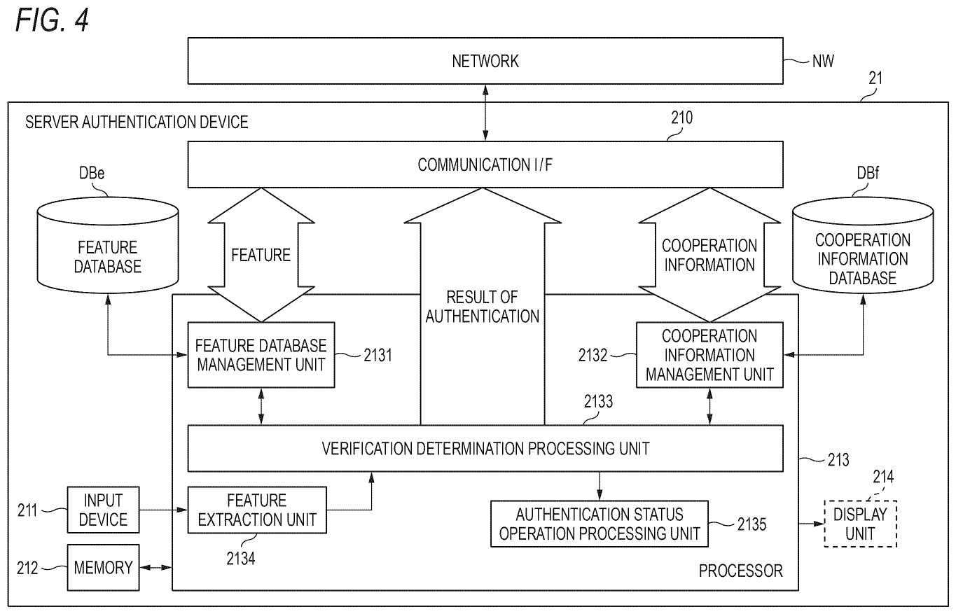

Next, a hardware configuration of the server authentication device having an authentication information input function will be described with reference to FIG. 4. FIG. 4 is a block diagram of the server authentication device having an authentication information input function.

A server authentication device 21 illustrated in FIG. 4 is a server authentication device when the client authentication terminal 10 illustrated in FIG. 2 has the same function as the server authentication device 20. That is, the server authentication device 21 is a device including the feature data of all other client authentication terminals in a feature database DBe and including an input device 211.

The server authentication device 21 is installed in a facility such as an amusement park or a theme park. In such a facility, an entrance is limited, and authentication is always performed at the entrance when the authentication object enters. By setting an authentication terminal of the entrance in the server authentication device 21, the server authentication device 21 can first execute authentication by using all the authentication information. Thereafter, the server authentication device 21 can execute smooth authentication by transmitting the authentication information to a plurality of client authentication terminals installed in the facility based on the inter-client cooperation information.

A communication I/F 210 is a network interface circuit that performs wireless or wired communication with the network NW. The server authentication device 21 is communicably connected to the other client authentication terminals 10 (see FIG. 2) via the communication I/F 210 and the network NW. The server authentication device 21 may be communicably connected to the server authentication device 20. Examples of a communication method used for communication in the communication I/F 200 include mobile communication such as WAN, LAN, LTE, and 5G, power line communication, near field communication (for example, Bluetooth (registered trademark) communication), or communication for mobile phones. The communication I/F 200 acquires the feature data transmitted from the client authentication terminal 10 via the network NW. The communication I/F 210 transmits the acquired feature data to a feature database management unit 2131.

The feature database DBe is implemented by a storage medium (for example, a flash memory, a HDD, and an SSD). Similar to the feature database DBc of the server authentication device 20, the feature database DBe retains the feature data of all of the other client authentication terminals. The feature database DBe transmits the feature data to the feature database management unit 2131.

A cooperation information database DBf is implemented by a storage medium (for example, a flash memory, a HDD, and an SSD). Similar to the cooperation information database DBd of the server authentication device 20, the cooperation information database DBf retains the inter-client cooperation information of all of the plurality of client authentication terminals. The cooperation information database DBf transmits the inter-client cooperation information to a cooperation information management unit 2132.

The input device 211 inputs information of a person who visits an installation position of the server authentication device 21. For example, the input device 211 is a camera, a fingerprint authentication device, a microphone, a scanner, or a touch panel display. Examples of the input device 211 are merely examples, and the input device 211 is not limited thereto. The server authentication device 21 may include a plurality of devices as the input device 211. The input device 211 transmits the acquired data to a feature extraction unit 2134.

A memory 212 includes, for example, a RAM as a work memory used when each processing of a processor 213 is executed, and a ROM that stores a program and data that define an operation of the processor 213. The RAM temporarily stores data or information generated or acquired by the processor 213. The program that defines the operation of the processor 213 is written into the ROM.

The processor 213 is implemented by, for example, a CPU, a DSP, a GPU, or a FPGA, and performs various types of processing and control in cooperation with the memory 212. Specifically, the processor 213 executes various types of operations to be performed by the processor 213 by referring to the program and data retained in the memory 212 and executing the program. The processor 213 integrally controls the server authentication device 21. The processor 213 implements functions of the feature database management unit 2131, the cooperation information management unit 2132, a verification determination processing unit 2133, the feature extraction unit 2134, and an authentication status operation processing unit 2135. During operation, the processor 213 uses the RAM of the memory 212 to temporarily store data generated or acquired by each unit of the processor 213.

The feature database management unit 2131 manages the feature data. The feature database management unit 2131 transmits the feature data acquired from the feature database DBe to the verification determination processing unit 2133. The feature database management unit 2131 manages transmission and reception of the feature data to and from the communication I/F 210. The feature database management unit 2131 transmits the feature data acquired from the communication I/F 210 to the verification determination processing unit 2133 and the feature database.

The cooperation information management unit 2132 manages the cooperation information. The cooperation information management unit 2132 transmits the inter-client cooperation information acquired from the cooperation information database DBf to the verification determination processing unit 2023. The cooperation information management unit 2022 transmits the inter-client cooperation information to the communication I/F 200 in order to transmit the cooperation information to the client authentication terminal 10. The cooperation information management unit 1033 acquires the inter-client cooperation information transmitted from the client authentication terminal 10. The cooperation information management unit 2132 deletes the authentication information of the authentication object and the inter-client cooperation information having a passed expiration date.

The verification determination processing unit 2133 performs verification determination of a person based on the feature data acquired from the feature database management unit 2131 and the extracted feature extracted from the feature extraction unit 2134. The verification determination processing unit 2133 may perform multi-factor authentication. The verification determination processing unit 2133 transmits a result of the verification determination to the communication I/F 210.

The feature extraction unit 2134 extracts a feature from data acquired from the input device 211. The feature extraction unit 2134 transmits the extracted feature to the verification determination processing unit 2133.

The authentication status operation processing unit 2135 performs an operation according to the result of the verification determination acquired from the verification determination processing unit 2133.

A display unit 214 is, for example, a display. The display unit 214 displays the result of the verification determination or the situation of the verification determination processing. The server authentication device 21 may not include the display unit 214.

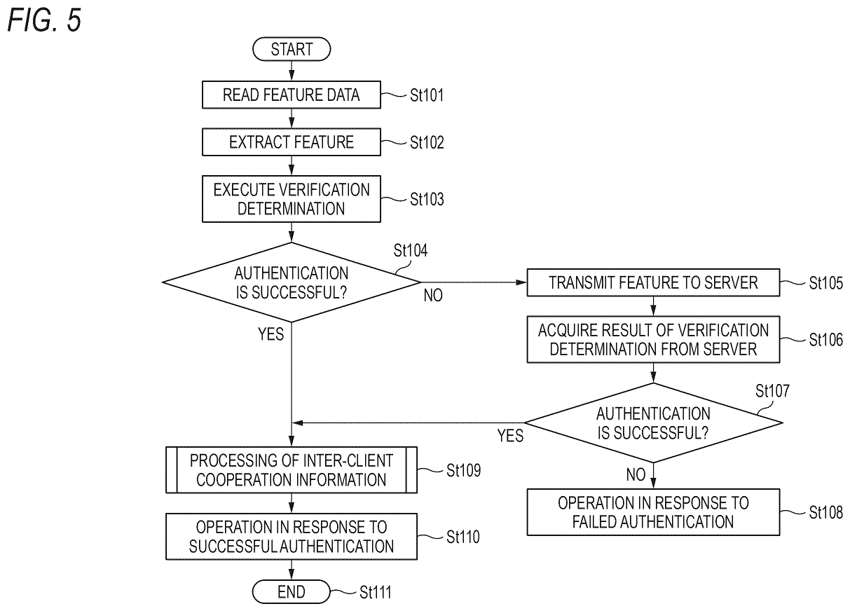

Next, authentication processing of a person in the client authentication terminal will be described with reference to FIG. 5. FIG. 5 is a flowchart of authentication processing of a person in the client authentication terminal. Each processing illustrated in FIG. 5 is performed by the processor 103 of the client authentication terminal 10.

The verification determination processing unit 1034 acquires all feature data necessary for verification from the feature database management unit 1031, and reads the feature data (step St101).

The feature extraction unit 1035 extracts a feature from data input to the input device 101 (step St102). The feature extraction unit 1035 transmits the extracted feature to the verification determination processing unit 1034.

The verification determination processing unit 1034 executes the verification determination based on all the feature data acquired in the processing of step St101 and the extracted feature extracted in the processing of step St102 (step St103).

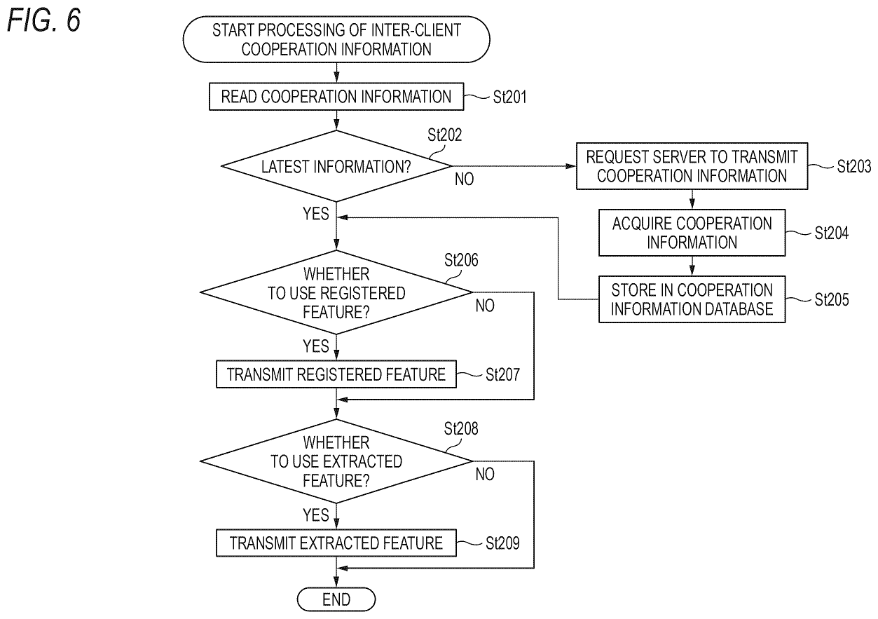

In response to determining that in the processing of step St103, a result of the verification determination related to the authentication of the person is successful (YES in step St104), the verification determination processing unit 1034 transmits a signal indicating that the verification determination is successful to the cooperation information management unit 1033 and the authentication status operation processing unit 1036. When the cooperation information management unit 1033 acquires the signal based on the processing of step St104, the cooperation information management unit 1033 executes processing of the inter-client cooperation information (step St109). The processing of step St109 will be described in detail with reference to FIG. 6.

The authentication status operation processing unit 1036 executes operation processing in response to the successful authentication based on the signal acquired in the processing of step St104 (step St110).

In response to determining that in the processing of step St103, the result of the verification determination related to the authentication of the person is failed (NO in step St104), the verification determination processing unit 1034 transmits a signal indicating that the authentication is failed to the server authentication processing unit 1032. The server authentication processing unit 1032 transmits the feature data to the server authentication device 20 based on the signal acquired from the verification determination processing unit 1034 (step St105).

The server authentication device 20 acquires the signal indicating that the authentication is failed and the feature data from the client authentication terminal 10. The verification determination processing unit 2023 of the server authentication device 20 executes the verification determination based on the acquired feature data. The verification determination processing unit 2023 outputs the result of the verification determination to the communication I/F 200 so as to transmit the result to the client authentication terminal 10. The verification determination processing unit 1034 of the client authentication terminal 10 acquires the result of the verification determination executed by the server authentication device 20 from the server authentication device 20 (step St106).

The verification determination processing unit 1034 determines whether the result of the verification determination related to the authentication of the person acquired in the processing of step St106 is successful. In response to determining that the result of the verification determination is failed (NO in step St107), the verification determination processing unit 1034 transmits a signal indicating that the result of the verification determination is failed to the authentication status operation processing unit 1036.

The authentication status operation processing unit 1036 executes operation processing in response to the failed authentication based on the signal acquired in the processing of step St107 (step St108).

In response to the verification determination processing unit 1034 determining that the result of the verification determination is successful (YES in step St107), the processing of the verification determination processing unit 1034 proceeds to the processing of step St109.

Next, the cooperation processing of the inter-client cooperation information executed by the client authentication terminal will be described with reference to FIG. 6. FIG. 6 is a flowchart of the cooperation processing of the inter-client cooperation information executed by the client authentication terminal. Each processing illustrated in FIG. 6 is executed by the processor 103 of the client authentication terminal 10.

The cooperation information management unit 1033 reads the inter-client cooperation information from the cooperation information database DBb (step St201).

The cooperation information management unit 1033 determines whether the read inter-client cooperation information is the latest information (step St202). That is, in step St202, it is determined whether the inter-client cooperation information retained by the client authentication terminal 10 read in step St201 passes an expiration date. In response to determining that the inter-client cooperation information is the latest information (in other words, the inter-client cooperation information does not pass the expiration date) (YES in step St202), the cooperation information management unit 1033 determines a transmission destination of the authentication information based on the inter-client cooperation information. Thereafter, the processing of the processor 103 proceeds to processing of step St206.

In response to determining that the inter-client cooperation information is not the latest information (in other words, the inter-client cooperation information passes the expiration date) (NO in step St202), the cooperation information management unit 1033 requests the server authentication device 20 to transmit the inter-client cooperation information (step St203).

When the server authentication device 20 acquires the transmission request of the inter-client cooperation information in the processing of step St203, the server authentication device 20 transmits the inter-client cooperation information stored in the cooperation information database DBd of the server authentication device 20 to the client authentication terminal 10. The cooperation information management unit 1033 of the client authentication terminal 10 acquires the inter-client cooperation information from the server authentication device 20 (step St204).

The cooperation information management unit 1033 stores the inter-client cooperation information acquired in the processing of step St204 in the cooperation information database DBb (step St205). The cooperation information management unit 1033 determines the transmission destination of the authentication information based on the inter-client cooperation information. The processing of the cooperation information management unit 1033 proceeds to the processing of step StSt206.

The cooperation information management unit 1033 determines whether to use the registered feature based on the inter-client cooperation information (step St206). In response to determining that the registered feature is to be used (YES in step St206), the cooperation information management unit 1033 transmits the registered feature to the communication I/F 100 based on the inter-client cooperation information. The communication I/F 100 transmits the registered feature to the other client authentication terminals (step St207).

In response to the cooperation information management unit 1033 determining that the registered feature is not to be used based on the inter-client cooperation information (NO in step St206), the processing of the cooperation information management unit 1033 proceeds to processing of step St208.

The cooperation information management unit 1033 determines whether to use the extracted feature based on the inter-client cooperation information (step St208). In response to determining that the extracted feature is to be used (YES in step St208), the cooperation information management unit 1033 transmits the extracted feature to the communication I/F 100 based on the inter-client cooperation information. The communication I/F 100 transmits the extracted feature to the other client authentication terminals and the server authentication device 20 (step St209).

The communication I/F 100 transmits the authentication information to at least one of the (N−1) other client authentication terminals when the authentication executed by the verification determination processing unit 1034 is successful due to the processing of steps St207 and St209.

Next, an example of the inter-client cooperation information will be described with reference to FIG. 7. FIG. 7 is a diagram illustrating the example of the inter-client cooperation information. The client authentication terminal illustrated in FIG. 7 represents the client authentication terminal in the example illustrated in FIG. 1. The client authentication terminal is assumed to be installed in a positional relation illustrated in FIG. 1.

Cases No. (1) to (4) are all inter-client cooperation information related to the client authentication terminal 1. A parameter of the inter-client cooperation information is a parameter used to determine the transmission destination of the feature data. The parameter includes, for example, an environmental parameter, a personal parameter, and a position parameter. The environmental parameter includes, for example, information of a weather, a time when a person visits the client authentication terminal, or a position where the client authentication terminal is installed. The personal parameter includes, for example, information of the sex, age of a person, or a client authentication terminal which authenticated the person in the past. The position parameter includes, for example, information of an address of the client authentication terminal or a global positioning system (GPS). Examples of the environmental parameter, the personal parameter, and the position parameter are not limited to those described above.

The transmission destination of the inter-client cooperation information in the case No. (1) includes fixed transmission destinations. The case No. (1) has no parameter. A client authentication terminal which is the transmission destination of the feature data in the case No. (1) includes the client authentication terminal 2, the client authentication terminal 3, and the client authentication terminal 4, which are fixed transmission destinations. When the group GR1 is generated, the number of fixed transmission destinations from the client authentication terminal CLA corresponding to the client authentication terminal 1 is set to three, that is, the client authentication terminal CLB (the client authentication terminal 2), the client authentication terminal CLC (the client authentication terminal 3), and the client authentication terminal CLD (the client authentication terminal 4).

The transmission destination of the inter-client cooperation information in the case No. (2) includes the fixed transmission destinations and a transmission destination determined according to a condition of addition or deletion of a transmission destination due to the parameter. The case No. (2) has at least one of the environmental parameter, the personal parameter, and the position parameter as the parameter. The client authentication terminal serving as the transmission destination of the feature data in the case No. (2) includes the client authentication terminal 2, the client authentication terminal 3, the client authentication terminal 4, which are fixed transmission destinations, and the transmission destination determined by the condition. Therefore, according to the parameter, for example, the client authentication terminal 2 may be deleted from the transmission destination, or the client authentication terminal 5 may be added to the transmission destination.

The transmission destination of the inter-client cooperation information in the case No. (3) includes a transmission destination determined according to a condition of addition or deletion of the transmission destination due to the parameter. In the case No. 3, the client authentication terminal 1 is fixedly installed and does not move. The case No. (3) has at least one of the environmental parameter, the personal parameter, and the position parameters as the parameter. The client authentication terminal serving as the transmission destination of the feature data in the case No. (3) includes any one of the client authentication terminal 2, the client authentication terminal 3, the client authentication terminal 4, the client authentication terminal 5, and the client authentication terminal 6.

The transmission destination of the inter-client cooperation information in the case No. (4) includes a transmission destination determined according to a condition of addition or deletion of the transmission destination due to the parameter. In the case No. (4), the client authentication terminal 1 is installed on a moving body (for example, a bus, or a car), and the position of the client authentication terminal 1 moves. The case No. (4) has at least one of the environmental parameter, the personal parameter, and the position parameters as the parameter. The client authentication terminal serving as the transmission destination of the feature data in the case No. (4) includes any one of the client authentication terminal 2, the client authentication terminal 3, the client authentication terminal 4, the client authentication terminal 5, and the client authentication terminal 6.

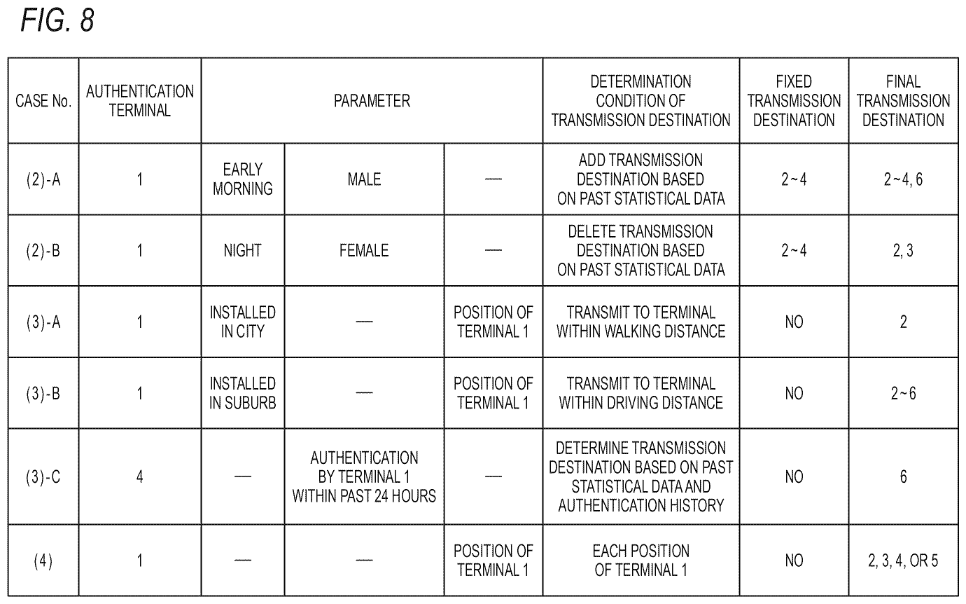

Next, an example of the transmission destination of the inter-client cooperation information based on conditions will be described with reference to FIG. 8. FIG. 8 is a diagram illustrating the example of the transmission destination of the inter-client cooperation information based on conditions. The case No. (2) illustrated in FIG. 8 represents the same case as the case No. (2) illustrated in FIG. 7. The same applies to the case No. (3) and the case No. (4).

A case No. (2)-A is a case in which a person visits the installation position of the client authentication terminal 1. In the case No. (2)-A, the person is a male and visits the client authentication terminal 1 in the early morning. That is, the parameter includes “early morning” and “male”. In the case No. (2)-A, the client authentication terminal 6 is added as the transmission destination of the feature data based on past statistical data. The fixed transmission destinations in the case No. (2)-A include the client authentication terminal 2, the client authentication terminal 3, and the client authentication terminal 4. The final transmission destinations of the feature data in the case No. (2)-A include the client authentication terminal 2, the client authentication terminal 3, the client authentication terminal 4, and the client authentication terminal 6. This is because it is predicted from past data that a male who visits the client authentication terminal 1 in the early morning is highly likely to visit the client authentication terminal 6 next.

A case No. (2)-B is a case in which a person visits the installation position of the client authentication terminal 1. In the case No. (2)-B, the person is a female and visits the client authentication terminal 1 at night. That is, the parameter includes “night” and “female”. In the case No. (2)-B, the client authentication terminal 4 is deleted as the transmission destination of the feature data based on the past statistical data. The fixed transmission destinations in the case No. (2)-B include the client authentication terminal 2, the client authentication terminal 3, and the client authentication terminal 4. The final transmission destinations of the feature data in the case No. (2)-A include the client authentication terminal 2 and the client authentication terminal 3. This is because it is predicted from the past data that a female who visits the client authentication terminal 1 at night is less likely to visit the client authentication terminal 4 next.

A case No. (3)-A is a case in which a person visits the installation position of the client authentication terminal 1. In the case No. (3)-A, the client authentication terminal 1 is installed in a city. That is, the parameter includes “installed in city” and “position of client authentication terminal 1”. In the case No. (3)-A, a client authentication terminal within a walking distance from the client authentication terminal 1 is determined as the transmission destination of the feature data. In the case No. (3)-A, there is no fixed transmission destination. The final transmission destination of the feature data in the case No. (3)-A includes the client authentication terminal 2. In the case No. (3)-A, a moving section of the person is estimated according to the installation position of the client authentication terminal 1 so as to determine the transmission destination.

A case No. (3)-B is a case in which a person visits the installation position of the client authentication terminal 1. In the case No. (3)-B, the client authentication terminal 1 is installed in a suburb. That is, the parameter includes “installed in suburb” and “position of client authentication terminal 1”. In the case No. (3)-B, a client authentication terminal within a driving distance from the client authentication terminal 1 is determined as the transmission destination of the feature data. In the case No. (3)-B, there is no fixed transmission destination. The final transmission destinations of the feature data in the case No. (3)-B include the client authentication terminal 2, the client authentication terminal 3, the client authentication terminal 4, the client authentication terminal 5, and the client authentication terminal 6. In the case No. (3)-B, the moving section of the person is estimated according to the installation position of the client authentication terminal 1 so as to determine the transmission destination of the feature data.

A case No. (3)-C is a case in which a person visits the installation position of the client authentication terminal 1. In the case No. (3)-C, the person is authenticated by the client authentication terminal 1 within the past 24 hours. That is, the parameter includes “authentication by client authentication terminal 1 within past 24 hours”. In the case No. (3)-C, the transmission destination of the feature data is determined based on the past statistical data and authentication history. In the case No. (3)-C, there is no fixed transmission destination. The final transmission destination of the feature data in the case No. (3)-C includes the client authentication terminal 6. In the case No. (3)-C, the transmission destination of the feature data is determined based on a fact that, for example, the person who visits the client authentication terminal 1 within 24 hours from a standard tourist route is highly likely to visit the client authentication terminal 6 thereafter.

The case No. (4) is a case in which a person is authenticated by the client authentication terminal 1. The case No. (4) is a case in which the position where the client authentication terminal 1 is installed moves. For example, the case No. (4) is a case in which the client authentication terminal 1 is installed in a bus. The specific example of the case No. (4) is not limited thereto. The parameter of the case No. (4) includes “position of client authentication terminal 1”. In the case No. (4), the transmission destination of the feature data is determined according to each position of the client authentication terminal 1. In the case No. (4), there is no fixed transmission destination. The final transmission destination of the feature data in the case No. (4) includes the client authentication terminal 2, the client authentication terminal 3, the client authentication terminal 4, and the client authentication terminal 5. In the case No. (4), the feature data is transmitted from a movement destination of the client authentication terminal 1 to a client authentication terminal to which the person may visit next.

In this manner, the authentication system 1 changes the inter-client cooperation information based on a predetermined condition. In addition, the inter-client cooperation information is changed based on the personal information of the authentication object who uses the authentication system 1.

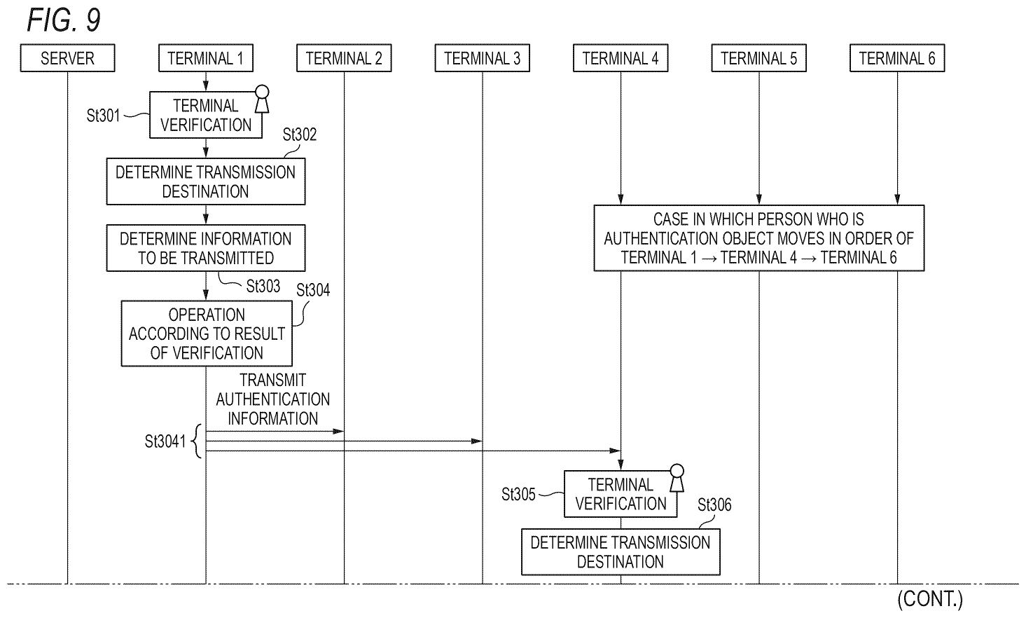

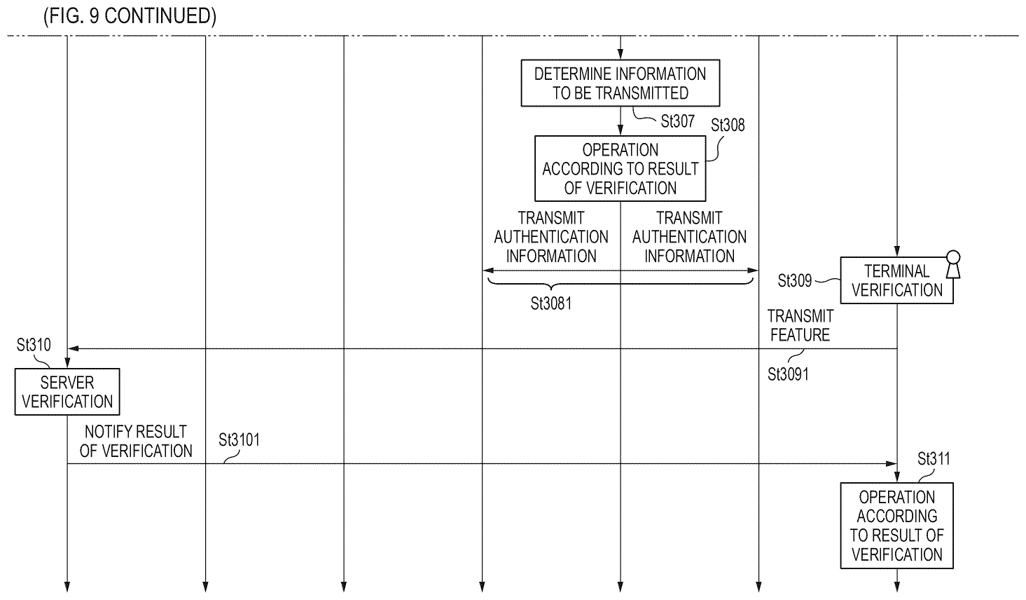

Next, processing in a case in which a person moves among a plurality of client authentication terminals and performs authentication will be described with reference to FIG. 9. FIG. 9 is a sequence diagram illustrating a case in which a person moves among a plurality of client authentication terminals and performs authentication.

The server illustrated in FIG. 9 is the server authentication device 20. A terminal 1 is the client authentication terminal 1. A terminal 2 is the client authentication terminal 2. A terminal 3 is the client authentication terminal 3. A terminal 4 is the client authentication terminal 4. A terminal 5 is the client authentication terminal 5. A terminal 6 is the client authentication terminal 6. Hereinafter, the server authentication device 20 is referred to as a “server”, and each client authentication terminal is referred to as a “terminal”.

When a person hm1 performs authentication in the terminal 1, the terminal 1 executes verification determination of the person hm1 (step St301). Hereinafter, the verification determination executed by the terminal will be referred to as terminal verification. It is assumed that the terminal verification is successful in the terminal 1.

The terminal 1 determines a transmission destination of feature data based on the inter-client cooperation information (step St302).

The terminal 1 determines feature data to be transmitted to other terminals (step St303).

The terminal 1 executes an operation according to a result of the terminal verification executed in the processing of step St301 (step St304). The operation is, for example, opening a gate or displaying on a display or the like a message indicating that authentication is successful.

The terminal 1 transmits the feature data determined in the processing of step St303 to terminals serving as the transmission destination determined in the processing of step St302. The terminal 1 transmits the feature data to the terminal 2, the terminal 3, and the terminal 4 (step St3041).

Next, the person hm1 moves to an installation position of the terminal 4 and performs authentication. The terminal 4 acquires the feature data transmitted in the processing of step St3041 in advance. The terminal 4 executes the terminal verification of the person hm1 (step St305). That is, the terminal 4 authenticates the person hm1 by using authentication information of the person hm1 who is an authentication object acquired from at least one of the (N−1) other client authentication terminals via the communication I/F 100. The terminal 4 succeeds in the terminal verification because the feature data of the person hm1 is acquired in the processing of step St3041.

The terminal 4 determines a transmission destination of the feature data based on the inter-client cooperation information (step St306).

The terminal 4 determines feature data to be transmitted to other terminals (step St307).

The terminal 4 executes an operation according to a result of the terminal verification executed in the processing of step St305 (step St308).

The terminal 4 transmits the feature data determined in the processing of step St306 to terminals serving as the transmission destination determined in the processing of step St306. The terminal 4 transmits the feature data to the terminal 3 and the terminal 5 (step St3081).

Next, the person hm1 moves to an installation position of the terminal 6 and performs authentication. The terminal 6 executes the terminal verification of the person hm1 (step St309). Since the terminal 6 has no feature data of the person hm1, the terminal verification is failed.

When executing the terminal verification in the processing of step St309, the terminal 6 transmits the feature data acquired from an input device mounted on the terminal 6 to the server (step St3091).

When the server acquires the feature data of the person hm1 in the processing of step St3091, the server executes the verification on the server (hereinafter, referred to as server verification) (step St301).

The server transmits a result of the server verification related to the processing of step St310 to the terminal 6 (step St3101).

The terminal 6 executes an operation according to the result of the server verification related to the processing of step St310 (step St311). When the result of the server verification related to the processing of step St310 is successful, the terminal 6 transmits the authentication information used for the server verification to other client authentication terminals based on the inter-client cooperation information.

Accordingly, the client authentication terminal 10 transmits the authentication information to at least one of the (N−1) other client authentication terminals when at least one of the authentication processing of the authentication object by the own client authentication terminal and the authentication processing of the authentication object by the server authentication device 20 is successful.

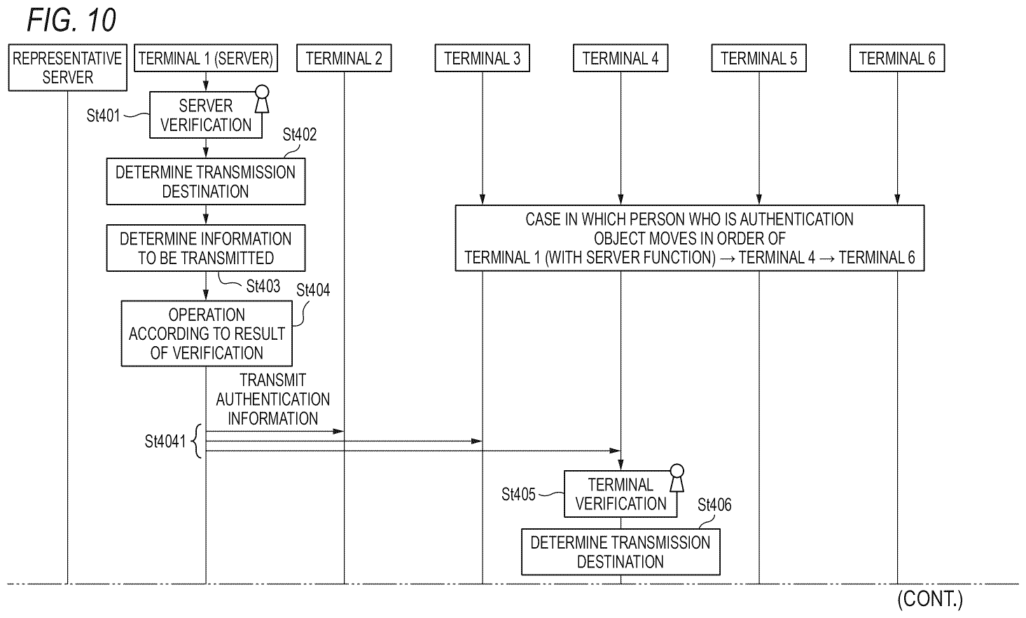

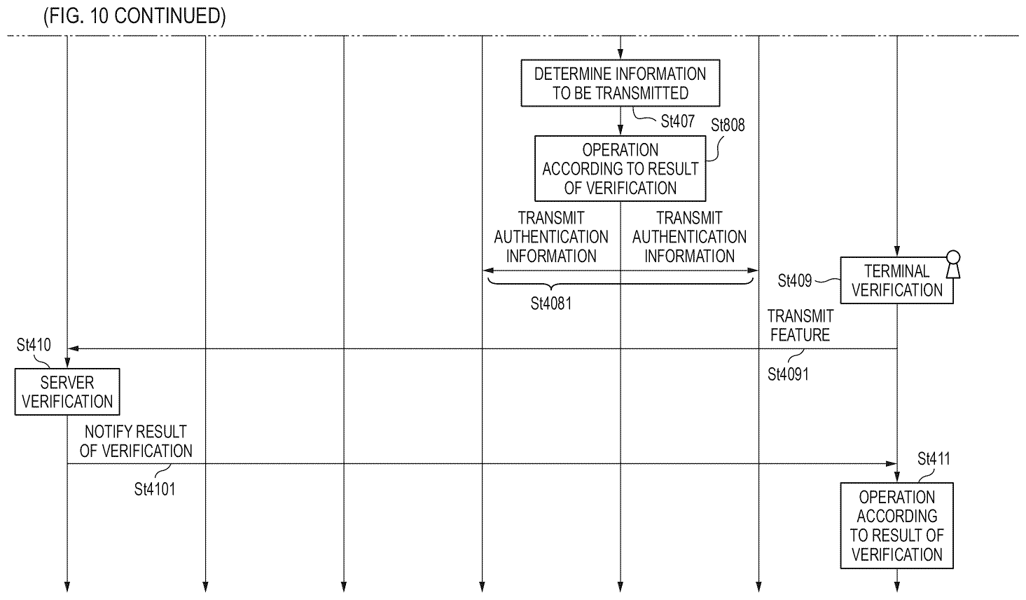

Next, processing in a case in which a person performs authentication in an authentication system including a server authentication device having an authentication information input function will be described with reference to FIG. 10. FIG. 10 is a sequence diagram illustrating a case in which the person performs authentication in an authentication system including a server authentication device having an authentication information input function.

The representative server illustrated in FIG. 10 is the server authentication device 20. The respective terminals are the same as those in FIG. 9. The terminal 1 has the same function as the server authentication device 21. Hereinafter, the server authentication device 20 is referred to as a “representative server”, and each client authentication terminal is referred to as a “terminal”.

When the person hm1 performs authentication in the terminal 1, the terminal 1 executes server verification of the person hm1 (step St401). Since the terminal 1 serving as the server authentication device 21 has all of the authentication information of the person serving as the authentication object, the authentication is successful.

The terminal 1 determines a transmission destination of the feature data based on the inter-client cooperation information (step St402).

The terminal 1 determines feature data to be transmitted to other terminals (step St403).

The terminal 1 executes an operation according to a result of the server verification executed in the processing of step St401 (step St404).

The terminal 1 transmits the feature data determined in the processing of step St403 to terminals serving as the transmission destination determined in the processing of step St402.

The terminal 1 transmits the feature data to the terminal 2, the terminal 3, and the terminal 4 (step St4041).

Next, the person hm1 moves to the terminal 4 and performs authentication. The terminal 4 acquires the feature data transmitted in the processing of step St4041. The terminal 4 executes terminal verification of the person hm1 (step St405). The terminal 4 succeeds in the terminal verification because the feature data of the person hm1 is acquired in the processing of step St4041.

The terminal 4 determines a transmission destination of the feature data based on the inter-client cooperation information (step St406).

The terminal 4 determines feature data to be transmitted to other terminals (step St407).

The terminal 4 executes an operation according to a result of the terminal verification executed in the processing of step St405 (step St408).

The terminal 4 transmits the feature data determined in the processing of step St306 to terminals serving as the transmission destination determined in the processing of step St406. The terminal 4 transmits the feature data to the terminal 3 and the terminal 5 (step St4081).

Next, the person hm1 moves to the terminal 6 and performs authentication. The terminal 6 executes terminal verification of the person hm1 (step St409). Since the terminal 6 has no feature data of the person hm1, the terminal verification is failed.

When executing the terminal verification in the processing of step St409, the terminal 6 transmits the feature data acquired from an input device mounted on the terminal 6 to the server (step St4091).

When the server acquires the feature data of the person hm1 in the processing of step St4091, the server executes server verification (step St301).

The server transmits a result of the server verification related to the processing of step St410 to the terminal 6 (step St4101).

The terminal 6 executes an operation according to the result of the server verification related to the processing of step St410 (step St411).

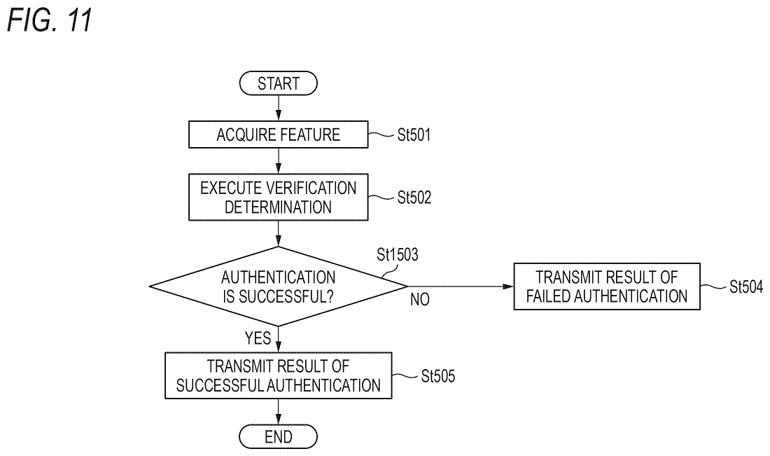

Next, authentication processing of a person in the server authentication device will be described with reference to FIG. 11. FIG. 11 is a flowchart of authentication of a person in the server authentication device. Each processing of the flowchart illustrated in FIG. 11 is executed by the processor 202 of the server authentication device 20.

The feature database management unit 2021 acquires the feature data transmitted from the client authentication terminal 10 (step St501). The feature database management unit 2021 transmits the feature data acquired in the processing of step St501 to the verification determination processing unit 2023.

The verification determination processing unit 2023 executes verification determination of the person (step St502).

The verification determination processing unit 2023 determines whether the authentication is successful based on a result of the verification determination related to the processing of step St502 (step St503).

In response to determining that the authentication is failed (NO in step St503), the verification determination processing unit 2023 transmits a signal indicating that the authentication is failed to the communication I/F 200 (step St504). The communication I/F 200 transmits the signal indicating that the authentication is failed acquired in the processing of step St504 to the client authentication terminal 10.

In response to determining in the processing of step St503 that the authentication is successful (YES in step St503), the verification determination processing unit 2023 transmits a signal indicating that the authentication is successful to the communication I/F 200 (step St505). The communication I/F 200 transmits the signal indicating that the authentication is successful acquired in the processing of step St505 to the client authentication terminal 10.

As described above, the client authentication terminal 10 according to the present embodiment is a client authentication terminal belonging to an authentication system 1 including N (N is an integer constant equal to or greater than 2) client authentication terminals. The client authentication terminal 10 includes: a verification determination processing unit 1034 configured to execute authentication processing of an authentication object based on authentication information of the authentication object; and a communication I/F 100 configured to transmit the authentication information via a network NW to at least one of (N−1) other client authentication terminals which are of the N client authentication terminals and are other than the own client authentication terminal.

Accordingly, the client authentication terminal 10 can share the authentication information with the other client authentication terminals and execute the authentication of the authentication object by the client authentication terminal. Accordingly, overconcentration on a specific device can be avoided, and efficiency of the authentication processing of the authentication object can be improved.

The communication I/F 100 according to the present embodiment is configured to transmit the authentication information to at least one of the (N−1) other inter-client authentication terminals when authentication by the verification determination processing unit 1034 is successful. Accordingly, the client authentication terminal 10 can share the authentication information with other client authentication terminals when the authentication of the authentication object is successful. Accordingly, overconcentration on a specific device can be avoided, and efficiency of the authentication processing of the authentication object can be improved.

The verification determination processing unit 1034 of the client authentication terminal 10 according to the present embodiment is configured to authenticate the authentication object by using the authentication information of the authentication object acquired from at least one of the (N−1) other client authentication terminals via the communication I/F 100. Accordingly, the client authentication terminal 10 can execute the authentication processing of the authentication object authenticated by other client authentication terminals. The client authentication terminal 10 can efficiently execute the authentication processing of the authentication object in cooperation with the other client authentication terminals.

The client authentication terminal 10 according to the present embodiment further includes a cooperation information database DBb configured to store the authentication information of the authentication object and inter-client cooperation information between the N client authentication terminals. The communication I/F 100 is configured to transmit the authentication information to at least one of the (N−1) other client authentication terminals based on the inter-client cooperation information stored in the cooperation information database DBb. Accordingly, the client authentication terminal 10 transmits the authentication information only to the other client authentication terminal expected to be visited next by the authentication object, and thus a communication load can be reduced.

The client authentication terminal 10 according to the present embodiment further includes a cooperation information management unit 1033 configured to manage the inter-client cooperation information including information of an expiration date and the authentication information of the authentication object. The cooperation information management unit 1033 is configured to delete the inter-client cooperation information having a passed expiration date. Accordingly, the client authentication terminal 10 can prevent an excessive increase in data capacities of the feature database DBa and the cooperation information database DBb. The client authentication terminal 10 can improve authentication accuracy by deleting old authentication information of the authentication object.

The inter-client cooperation information according to the present embodiment includes at least one of a transmission destination of the authentication information, an environmental parameter, a personal parameter, and a position parameter. Accordingly, the client authentication terminal 10 can efficiently share the authentication information with other client authentication terminals based on the respective parameters of the inter-client cooperation information.

The authentication information according to the present embodiment is an extracted feature extracted from the authentication object or a registered feature extracted in advance from the authentication object and registered. Accordingly, the client authentication terminal 10 can execute the authentication processing of the authentication object based on the extracted feature or the registered feature.

The authentication system 1 according to the present embodiment includes: a server authentication device 20 or a server authentication device 21; and N (N is an integer constant equal to or greater than 2) client authentication devices 10. The client authentication terminal 10 is configured to execute authentication processing of an authentication object based on authentication information of the authentication object, and transmit and receive the authentication information to and from the server authentication device 20 or to and from at least one of (N−1) other client authentication terminals which are of the N client authentication terminals 10 and are other than the own client authentication terminal. Accordingly, the authentication system 1 can execute the authentication of the authentication object in cooperation with the server authentication device 20 and the N client authentication terminals 10. Accordingly, the authentication system 1 can efficiently execute the authentication of the authentication object by sharing the authentication information between the server authentication device 20 and the client authentication terminal 10. Accordingly, overconcentration on a specific device can be avoided, and efficiency of the authentication processing of the authentication object can be improved.

The server authentication device 20 or the server authentication device 21 according to the present embodiment is configured to execute the authentication processing of the authentication object by using the authentication information transmitted from the client authentication terminal 10. Accordingly, the authentication system 1 can authenticate the authentication object by using all the authentication information.

The client authentication terminal 10 according to the present embodiment is configured to transmit the authentication information to at least one of the (N−1) other client authentication terminals 10 when at least one of the authentication processing of the authentication object by the own client authentication terminal and authentication processing of the authentication object by the server authentication device 20 or the server authentication device 21 is successful. Accordingly, the authentication system 1 can share the authentication information with other client authentication terminals when the authentication of the authentication object is successful. Accordingly, overconcentration on a specific device can be avoided, and efficiency of the authentication processing of the authentication object can be improved.

In the present embodiment, the server authentication device 20 or the server authentication device 21 and the N client authentication terminals 10 have inter-client cooperation information between the server authentication device 20 or the server authentication device 21 and the N client authentication terminals 10. Accordingly, the authentication system 1 can share the authentication information between the server authentication device 20 or the server authentication device 21 and the client authentication terminal based on the inter-client cooperation information.

The inter-client cooperation information includes at least one of a transmission destination of the authentication information, an environmental parameter, a personal parameter, and a position parameter. Accordingly, the authentication system 1 can efficiently share the authentication information based on the respective parameters of the inter-client cooperation information.

In the present embodiment, the server authentication device 20 or the server authentication device 21 or the client authentication terminal 10 succeeded in the authentication processing of the authentication object related to the authentication system 1 is configured to retain at least one of an extracted feature extracted from the authentication object or a registered feature extracted in advance from the authentication object and registered. Accordingly, the authentication system 1 can execute the authentication processing of the authentication object based on at least one of the extracted feature and the registered feature.

The inter-client cooperation information according to the present embodiment includes expiration date information of the inter-client cooperation information. Accordingly, the authentication system 1 can delete the inter-client cooperation information based on the expiration date information.

In the authentication system 1 according to the present embodiment, the server authentication device 20 or the server authentication device 21 and the N client authentication terminals 10 are configured to delete the inter-client cooperation information having a passed expiration date based on the expiration date information. Accordingly, the authentication system 1 can prevent an excessive increase in a capacity of the database of the server authentication device 20, the server authentication device 21, or the client authentication terminal 10. The authentication system 1 can improve the authentication accuracy by deleting old authentication information of the authentication object.

The server authentication device 20 or the server authentication device 21 and the N client authentication terminals 10 according to the present embodiment are configured to change the inter-client cooperation information based on a predetermined condition. Accordingly, the authentication system 1 can change the inter-client cooperation information according to a situation of a position where the client authentication terminal 10 is installed.

The server authentication device 20 or the server authentication device 21 and the N client authentication terminals 10 according to the present embodiment are configured to change the inter-client cooperation information based on personal information of the authentication object who uses the authentication system 1. Accordingly, the authentication system 1 can flexibly share the authentication information by using the inter-client cooperation information which is estimated to be optimal in accordance with the authentication object.

A condition defining the inter-client cooperation information according to the present embodiment is attributed to the authentication object. Accordingly, the authentication system 1 can flexibly share the authentication information by using the inter-client cooperation information which is estimated to be optimal in accordance with characteristics of the authentication object.

The authentication system 1 according to the present embodiment is configured to transmit and receive, based on the inter-client cooperation information, a plurality of types of authentication information to be used in multi-factor authentication to and from the server authentication device 20 or the server authentication device 21 configured to execute the multi-factor authentication. Accordingly, the authentication system 1 can authenticate the authentication object with higher accuracy through the multi-factor authentication function.

Although the embodiments have been described above with reference to the accompanying drawings, the present disclosure is not limited thereto. It is apparent to those skilled in the art that various modifications, corrections, substitutions, additions, deletions, and equivalents can be conceived within the scope described in the claims, and it is understood that such modifications, corrections, substitutions, additions, deletions, and equivalents also fall within the technical scope of the present disclosure. In addition, components in the embodiment described above may be combined freely in a range without departing from the gist of the invention.

The present application is based on Japanese Patent Application No. 2022-047176 filed on Mar. 23, 2022, and the contents thereof are incorporated herein by reference.

### INDUSTRIAL APPLICABILITY

The technique of the present disclosure is useful as an authentication device, an authentication method, and an authentication system that avoid overconcentration of processing execution on a specific device and improve efficiency of the authentication processing of the authentication object.

### REFERENCE SIGNS LIST

1: authentication system
10: client authentication terminal
20, 21: server authentication device
100, 200, 210: communication I/F
101, 211: input device
102, 201, 212: memory
103, 202, 213: processor
104, 214: display unit
1031, 2021, 2131: feature database management unit
1032: server authentication processing unit
1033, 2022, 2132: cooperation information management unit
1034, 2023, 2133 verification determination processing unit
1035, 2134 feature extraction unit
1036, 2135 authentication status operation processing unit
DBa, DBc, DBe feature database
DBb, DBd, DBf cooperation information database
CLA client authentication terminal 1
CLB client authentication terminal 2
CLC client authentication terminal 3
CLD client authentication terminal 4
CLE client authentication terminal 5
CLF client authentication terminal 6
GR1, GR6 group
IF information
NW network
hm, hm1 person

1. An authentication device belonging to an authentication system including N authentication devices, where N is an integer constant equal to or greater than 2, the authentication device comprising:
an authentication unit that executes authentication processing of an authentication object based on authentication information of the authentication object; and
a communication unit that transmits the authentication information via a network to at least one of (N−1) other authentication devices which are of the N authentication devices and are other than the own authentication device.

2. The authentication device according to claim 1, wherein
the communication unit transmits the authentication information to at least one of the (N−1) other authentication devices when authentication by the authentication unit is successful.

3. The authentication device according to claim 1, wherein
the authentication unit authenticates the authentication object by using the authentication information of the authentication object acquired from at least one of the (N−1) other authentication devices via the communication unit.

4. The authentication device according to claim 1, further comprising:
a storage unit that stores the authentication information of the authentication object and cooperation information between the N authentication devices, wherein
the communication unit transmits the authentication information to at least one of the (N−1) other authentication devices based on the cooperation information stored in the storage unit.

5. The authentication device according to claim 4, further comprising:
a management unit that manages the cooperation information including information of an expiration date and the authentication information of the authentication object, wherein
the management unit deletes the cooperation information having a passed expiration date.

6. The authentication device according to claim 4, wherein
the cooperation information includes at least one of a transmission destination of the authentication information, an environmental parameter, a personal parameter, and a position parameter.

7. The authentication device according to claim 1, wherein
the authentication information is a feature extracted from the authentication object or a registered feature extracted in advance from the authentication object and registered.

8. An authentication method performed by an authentication device belonging to an authentication system including N authentication devices, N is an integer constant equal to or greater than 2, the authentication method comprising:
executing authentication processing of an authentication object based on authentication information of the authentication object; and
transmitting the authentication information via a network to at least one of (N−1) other authentication devices which are of the N authentication devices and are other than the own authentication device.

9. An authentication system comprising:
a server device; and
N authentication devices, N is an integer constant equal to or greater than 2, wherein
the authentication device executes authentication processing of an authentication object based on authentication information of the authentication object, and
the authentication device transmits and receives the authentication information to and from the server device, or to and from at least one of (N−1) other authentication devices which are of the N authentication devices and are other than the own authentication device.

10. The authentication system according to claim 9, wherein
the server device executes the authentication processing of the authentication object by using the authentication information transmitted from the authentication device.

11. The authentication system according to claim 9, wherein
the authentication device transmits the authentication information to at least one of the (N−1) other authentication devices when at least one of the authentication processing of the authentication object by the own authentication device and authentication processing of the authentication object by the server device is successful.

12. The authentication system according to claim 9, wherein
the server device and the N authentication devices have cooperation information between the server device and the N authentication devices.

13. The authentication system according to claim 12, wherein
the cooperation information includes at least one of a transmission destination of the authentication information, an environmental parameter, a personal parameter, and a position parameter.

14. The authentication system according to 12, wherein
the server device or the authentication device succeeded in the authentication processing of the authentication object retains at least one of a feature extracted from the authentication object or a registered feature extracted in advance from the authentication object and registered.

15. The authentication system according to claim 12, wherein
the cooperation information includes expiration date information of the cooperation information.

16. The authentication system according to claim 15, wherein
the server device and the N authentication devices delete the cooperation information having a passed expiration date based on the expiration date information.

17. The authentication system according to claim 12, wherein
the server device and the N authentication devices change the cooperation information based on a predetermined condition.

18. The authentication system according to claim 16, wherein
the server device and the N authentication devices change the cooperation information based on personal information of the authentication object who uses the authentication system.

19. The authentication system according to claim 12, wherein
a condition defining the cooperation information is attributed to the authentication object.

20. The authentication system according to claim 12, wherein
the authentication device transmits and receives, based on the cooperation information, a plurality of types of authentication information to be used in multi-factor authentication to and from the server device configured to execute the multi-factor authentication.
